(19) United States
(12) Patent Application Publication
(10) Pub. No.: US 2008/0053328 A1
(43) Pub. Date: Mar. 6, 2008

(54) Printing method and apparatus

(76) Inventor: Ricardo C. Ximenes, Los Lunas, NM (US)

Correspondence Address: V. Gerald Grafe, esq., P.O. Box 2689, Corrales, NM, 87048, US

(21) Appl. No.: 11/512,643

(22) Filed: Aug. 30, 2006

(51) Int. Cl. B41F 33/00

(52) U.S. Cl. 101/484

(57) ABSTRACT

A method of configuring a printable item for use with a printer, where the printer has a maximum allowable item thickness and a maximum allowable item thickness variation, and where the thickness of the printable item varies by more than the maximum allowable item thickness variation. The method involves providing a conformable substrate material; placing the printable item in contact with the substrate material, forming a composite item; and treating the composite item such that the final thickness of the composite item is not more than the maximum allowable item thickness and such that the variation in thickness of the composite item is not more than the maximum allowable item thickness variation.

### BACKGROUND OF THE INVENTION

This invention relates to the field of printing, specifically to methods and apparatuses for printing directly on materials such as fabrics.

Textile printing, the various processes by which fabrics are printed in colored design, is an ancient art. Although the time and place of origin are uncertain, examples of Greek fabrics from the 4th cent. B.C. have been found. India exported block prints to the Mediterranean region in the 5th cent. B.C., and Indian chintz was imported into Europe during the Renaissance and widely imitated. Early forms of textile printing include stencil work and block printing. In the latter method a block of wood, copper, or other material bearing a design in intaglio with the dye paste applied to the surface is pressed on the fabric and struck with a mallet. A separate block is used for each color, and pitch pins at the corners guide the placing of the blocks to assure accurate repeating of the pattern. In cylinder or roller printing, developed c.1785, the fabric is carried on a rotating central cylinder and pressed by a series of rollers each bearing one color. The design is engraved on the copper rollers by hand or machine pressure or etched by pantograph or photoengraving methods; the color paste is applied to the rollers through feed rollers rotating in a color box, the color being scraped off the smooth portion of the rollers with knives.

More recent printing processes include screen printing, a hand method especially suitable for large patterns with soft outlines, in which screens, one for each color, are placed on the fabric and the color paste pressed through by a wooden squeegee; spray printing, in which a spray gun forces the color through a screen; and electrocoating, used to apply a patterned pile. Color may be applied by the various processes directly; by the discharge method, which uses chemicals to destroy a portion of a previously dyed ground; or by the resist, or reserve, method, which prevents the development of a subsequently applied color to a portion of the fabric treated with a chemical or with a mechanical resist.

More recently, ink jet printing technology has been applied to printing on fabrics. Manufacturers of consumer ink jet printers publish instructions for using their printers to print directly on fabric. See, e.g., http://h30039.www3.hp.com/guilting/articles_howtos/art_Print_on_fabric.asp, visited Jul. 22, 2004. In those applications, letter-sized pieces of fabric are treated with an ink fixative, and bonded to paper. A seam allowance must be kept around the borders of the piece, and care must be exercised to prevent any loose threads, bubbles, or other variations in thickness or shape which would interfere with the operation of the printer. The application is suitable for home crafters, as an example for printing on fabric pieces to be incorporated into quilts. See, e.g., http://www.compuquilt.com/prtonfab.htm, visited Jul. 22, 2004; http://quilting.about.com/library/weekly/aa101199.htm, visited on Jul. 22, 2004.

Ink jet technology is also applied for larger volume applications. Room-sized ink jet printers are combined with digital technology to allow production of individual bolts of cloth with custom patterns. See, e.g., http://www.dupont.com/inkjet/new/index.html, visited Jul. 22, 2004; http://textileinfo.com/en/manage/ronten/inkjet/page12.html, visited Jul. 22, 2004. Some aspects of ink jet printing onto textiles have been patented. See, e.g., U.S. Pat. No. 6,623,532; U.S. Pat. No. 6,467,898; U.S. Pat. No. 6,312,123. In all of these, the edges of the textile are left as seam allowances or used as non-printable borders. Care must also be taken to ensure that the textile is flat, and is fed across rollers that rely on the textile's uniform thickness to present a uniform surface for printing. See, e.g., U.S. Pat. No. 6,168,269, concerning a specific method of handling a flat textile in ink jet printing.

Once a desired design is printed on the fabric, the fabric can be cut into pieces and sewn into the final article, e.g., a scarf or clothing. Current technology requires that the printing be complete before any cutting or sewing, since both frayed cut edges and irregular shapes and thicknesses are incompatible with current printing processes. Even a simple scarf requires hemmed edges to prevent fraying, and the variations in thickness due to the hem preclude printing after hemming.

While contemporary printing technology allows relatively small volume production of custom textiles, it can only produce printed fabric; the final articles must be made after printing is complete. This prevents efficient one-of-a-kind production, where a single finished article can be customized with a print chosen by a customer.

Accordingly, there is a need for methods and apparatuses for printing that allow current printing technology to be used with fabrics that have already been configured in final form, such as with serged or hemmed edges.

### SUMMARY OF THE INVENTION

The present invention provides a method of configuring a printable item for use with a printer, where the printer has a maximum allowable item thickness and a maximum allowable item thickness variation, and where the thickness of the printable item varies by more than the maximum allowable item thickness variation. The method involves providing a conformable substrate material; placing the printable item in contact with the substrate material, forming a composite item; and treating the composite item such that the final thickness of the composite item is not more than the maximum allowable item thickness and such that the variation in thickness of the composite item is not more than the maximum allowable item thickness variation.

The printable item can be, as examples, textile items and fabrics such as hemmed silk scarves, cotton handkerchiefs, or twill or canvas items. For best performance with some inks, the items can be treated or coated to encourage surface properties that enhance the compatibility with the ink. Suitable treatments are known in the art, for example ink-retentive coatings as applied to inkjet printing on canvas, fabric, or paper.

The conformable substrate material can comprise, as examples, a compressible material, or an expansible material, or a coating that conforms to irregularities in the item and yields a consistent thickness once combined with the item. Examples of suitable compressible materials include waxed paper, soft paper, soft plastic such as sintra, soft cardboard, foam core, rice paper, and water-soluble paper. In many applications, the compressible material can be the same size or larger than the item, and have a stiffness that is compatible with the requirements of the printer, and have a thickness when combined with the item that is compatible with the requirements of the printer, e.g., one eighth of an inch or less with some contemporary printers. The printable item and a compressible substrate can be pressed together. As examples, applying pressure to the composite item can comprise passing the composite item through a roller press, wherein the space between the surfaces of the roller press is less than the maximum allowable item thickness; or placing the composite item between parallel plates as in a block press, and urging the parallel plates toward each other until their separation is not more than the maximum allowable item thickness, or placing the composite item in a vacuum press under conditions such that the final thickness variation is within allowable limits. Examples of suitable expansible materials and coatings include foams, expansible plastic, settable liquids and resins, and starch or paste. Processing of these can depend on the specifics of the material, and can involve spray application and subsequent self- or mechanical-leveling, vacuum expansion, and thermal or UV curing. Adhesion between the item and certain substrates can be enhanced with adherents, generally specific to the item and substrate materials.

Items prepared according to the present invention can be presented to a digital printer. As examples, sheet feeder mechanisms known in contemporary ink jet printers can be used. As examples, direct sheet feeders and feeder trays or bins can be used, such as those found in Epson's large format ink jet printers (e.g., Epson's model numbers 4000, 7600, and 9600). Digital representations of designs to be printed can be provided, for example in a print on demand method like that in U.S. patent application Ser. No. 09/974,621, “On-Demand Reproductions of Visual Images,” filed Oct. 10, 2001, incorporated herein by reference.

Advantages and novel features will become apparent to those skilled in the art upon examination of the following description or may be learned by practice of the invention. The objects and advantages of the invention may be realized and attained by means of the instrumentalities and combinations particularly pointed out in the appended claims.

### DESCRIPTION OF THE FIGURES

The accompanying drawings, which are incorporated into and form part of the specification, illustrate embodiments of the invention and, together with the description, serve to explain the principles of the invention.

FIG. 1 is a schematic representation of a printing apparatus suitable for use with the present invention.

FIG. 2(a,b) is a schematic representation of preparation of an item for printing according to the present invention.

FIG. 3(a,b) is a schematic representation of preparation of an item for printing according to the present invention.

FIG. 4(a,b) is a schematic representation of preparation of an item for printing according to the present invention.

FIG. 5(a,b) is a schematic representation of preparation of an item for printing according to the present invention.

### DETAILED DESCRIPTION OF THE INVENTION

The present invention provides a method of configuring a printable item for use with a printer, where the printer has a maximum allowable item thickness and a maximum allowable item thickness variation, and where the thickness of the printable item varies by more than the maximum allowable item thickness variation. The method involves providing a conformable substrate material; placing the printable item in contact with the substrate material, forming a composite item; and treating the composite item such that the final thickness of the composite item is not more than the maximum allowable item thickness and such that the variation in thickness of the composite item is not more than the maximum allowable item thickness variation.

The printable item can be, as examples, textile items and fabrics such as hemmed silk scarves, cotton handkerchiefs, or twill or canvas items. For best performance with some inks, the items can be treated. Suitable treatments are known in the art, for example as applied to inkjet printing on canvas, fabric, or paper.

The conformable substrate material can comprise, as examples, a compressible material, or an expansible material, or a coating that conforms to irregularities in the item and yields a consistent thickness once combined with the item. Examples of suitable compressible materials include waxed paper, soft paper, soft plastic such as sintra, soft cardboard, foam core, rice paper, and water-soluble paper. In many applications, the compressible material can be the same size or larger than the item, and have a stiffness that is compatible with the requirements of the printer, and have a thickness when combined with the item that is compatible with the requirements of the printer, e.g., one eighth of an inch or less with some contemporary printers. The printable item and a compressible substrate can be pressed together. As examples, applying pressure to the composite item can comprise passing the composite item through a roller press, wherein the space between the surfaces of the roller press is less than the maximum allowable item thickness; or placing the composite item between parallel plates as in a block press, and urging the parallel plates toward each other until their separation is not more than the maximum allowable item thickness, or placing the composite item in a vacuum press under conditions such that the final thickness variation is within allowable limits. Examples of suitable expansible materials and coatings include foams, expansible plastic, settable liquids and resins, and starch or paste. Processing of these can depend on the specifics of the material, and can involve spray application and subsequent self- or mechanical-leveling, vacuum expansion, and thermal or UV curing. Adhesion between the item and certain substrates can be enhanced with adherents, generally specific to the item and substrate materials.

Items prepared according to the present invention can be presented to a digital printer. As examples, sheet feeder mechanisms known in contemporary ink jet printers can be used. As examples, direct sheet feeders and feeder trays or bins can be used, such as those found in Epson's large format ink jet printers (e.g., Epson's model numbers 4000, 7600, and 9600). Digital representations of designs to be printed can be provided, for example in a print on demand method like that in U.S. patent application Ser. No. 09/974,621, “On-Demand Reproductions of Visual Images,” filed Oct. 10, 2001, incorporated herein by reference.

### Printing on Textiles

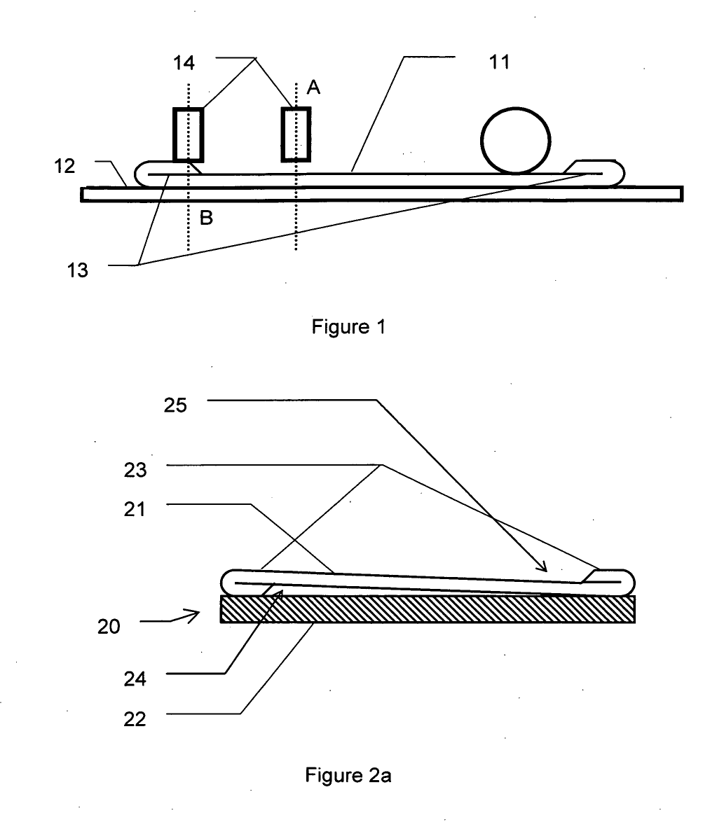

FIG. 1 is a schematic representation of some of the difficulties presented when printing directly on textiles. A representative printer is depicted by a reference plane 12 and a moveable print head 14. The representative printer is not intended to directly represent all printers, or specific mechanisms of suitable printers, but rather to present a simplified illustration of the problems encountered when printing on materials of uneven thickness. The print quality relies on precise delivery of pigment (typically ink) from the print head to the item 11 receiving the printing. This precise delivery generally requires consistent control of a very small separation between the print head 14 and the reference plane 12, with an allowance for the thickness of the item 11 placed therebetween. Items of uniform, consistent thickness are generally suitable for use with such printing processes. Items with thickness variations, however, can lead to poor quality or outright failure. As the example in the figure illustrates, the item 11 can comprise a textile with hemmed edges 13. The hemmed edges have a double layer of textile, plus stitching, together producing a significant variation in thickness. A print head 14 at position A will encounter a single textile thickness; at position B it will encounter a double thickness plus stitching. If the print head is a suitable distance from the reference plane 12 when at position A, then, when moved to position B, it is likely to be too close to the item 11, decreasing the print quality and possibly jamming the print head. A further difficulty can arise in feeding the item, as illustrated by feed roller 15. Reliable feeding generally requires consistent properties of the item being fed, including item thickness and rigidity. The hemmed edges 13 present very different properties: double or more thickness, and increased rigidity. The combination of varying print head distance and inconsistent feeding make high quality printing problematic for items with varying thickness.

### Example Application

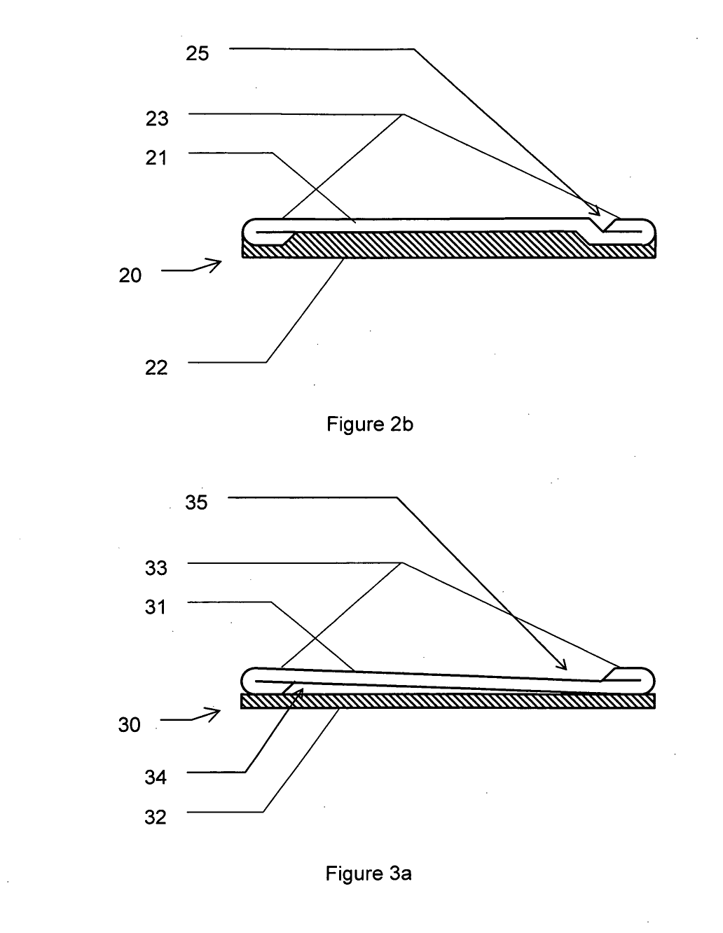

FIG. 2(a,b) is a schematic representation of the preparation of an item for printing according to the present invention. An item 21 to be printed is substantially planar, but has thickness variations such as hemmed or serged edges 23. In FIG. 2a, the item 21 is placed in contact with a compressible substrate 22, forming a composite item 20. The thickness variations of the item 21 can produce gaps 24 between the item 21 and the compressible substrate 22. It can also produce a nonplanar surface of the composite item where the item's thickness variation manifests 25. In FIG. 2b, the composite item 20 can be subjected to processing conditions such as pressure, preferentially compressing the compressible substrate 22 in the regions where the item 21 is relatively thicker. The resulting composite item 20 has a uniform thickness, with the gaps 24 and nonplanarities 25 reduced or eliminated by the differential compression of the compressible substrate 22.

In some applications of the present invention, the item can be a textile item with hemmed or serged edges. Examples of such include silk scarves, cotton handkerchiefs, and twill or flannel panels (e.g., for crafts or wall hangings). The compressible substrate can comprise materials such as foam core, thick and soft paper, mat board, and greyboard. Pressures of 10 psi to 100 psi can be suitable, depending on the item and the substrate material. About 30 psi can be suitable for commonly-available substrates.

### Example Application

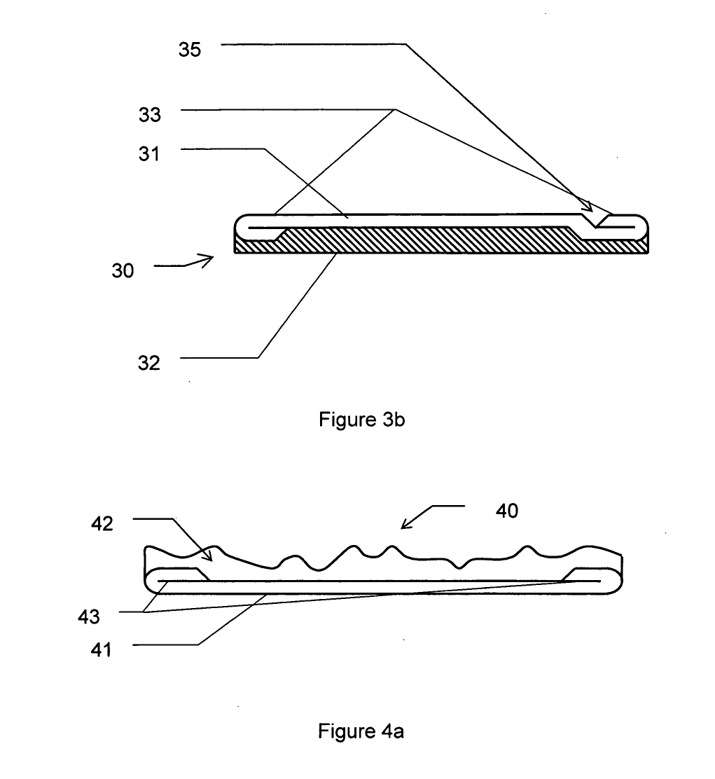

FIG. 3(a,b) is a schematic representation of the preparation of an item for printing according to the present invention. An item 31 to be printed is substantially planar, but has thickness variations such as hemmed edges 33. In FIG. 3a, the item 31 is placed in contact with an expansible substrate 32, forming a composite item 30. The thickness variations of the item 31 can produce gaps 34 between the item 31 and the expansible substrate 32. It can also produce a nonplanar surface of the composite item where the item's thickness variation manifests 35. The composite item 30 can be subjected to treatment, such as an appropriate vacuum or other environment conditions, while it is constrained to a planar configuration of acceptable thickness, yielding the item shown in FIG. 3b. The expansible substrate 32 can fill in the gaps 34 and smooth out nonplanarities 35, producing a composite item with a uniform thickness, with the gaps 34 and nonplanarities 35 reduced or eliminated by the differential expansion of the expansible substrate 32.

Items to be printed can include silk scarves, ties, clothing, pillowcases, purses, fabric components for complex items, linen, canvas, poplin, silk. Substrates can include foam core, rice paper, paper, and plastics. Substrates such as “Dissolvo”, a water-soluble paper material, can be used and then readily removed by water. Pressure required to conform the substrate can depend on the substrate, e.g., for foam core substrates about 30 psi can be suitable. For other substrates, pressures of from 10 psi to 100 psi can be suitable (depending on the substrate hardness or resistance to deformation). The composite item can be configured to a thickness of about 2 mm, after compression, for use with printing presses such as models currently available from Epson; other presses can accommodate greater thicknesses. The final thickness achieved can be designed to match the requirements of the printer to be used; available printers can be accommodate materials of thicknesses of ⅛ inch to ¼ inch. The combination of the item and the substrate can provide adequate stiffness for the requirements of the printer, although some flexibility can aid in handling. For use with roll-fed printers, more flexibility can be desired. For use with flat or single sheet fed printers, greater stiffness can be accommodated and can be desirable. The item and substrate can be conveniently handled by encouraging adherence between them, for example by disposing a polyurethane wax or 505 adhesive spray between the item and the substrate. The item, the substrate, or both can be exposed to heat, humidity, or both (e.g., by dampening the item, or use of a steam press) before or during compression to promote adhesion, encourage flatness, and facilitate conformance of the item and the substrate.

### Example Application

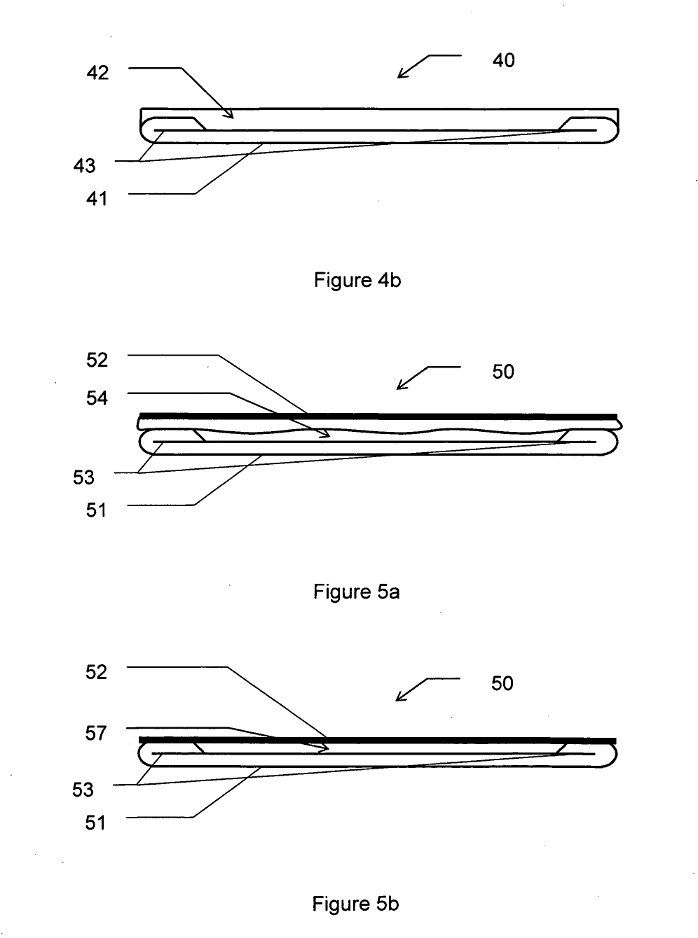

FIG. 4(a,b) is a schematic representation of the preparation of an item for printing according to the present invention. An item 41 to be printed is substantially planar, but has thickness variations such as hemmed edges 43. In FIG. 4a, the item 41 has been coated with a conformable material 42, forming a composite item 40. The conformable material can adhere to the item 41 with minimal voids between the coating 42 and the item 41. The conformable coating can then be leveled to yield a composite item with uniform thickness, as shown in FIG. 4b. Various ways to level the conformable coating are suitable. For example, the conformable coating can be cured, then planed level with, for example, a fixed knife or rotary cutting head. As another example, the composite item can be passed through a roller or parallel plate press to produce the desired consistent thickness, and then, if desired, any of the conformable material squeezed beyond the boundaries of the printable item can be removed. The conformable material can be cured after pressing. As another example, the conformable material can be leveled by passing through a fixed thickness opening or by passing a fixed height scraper over it, and then cured. The conformable material can be cured using various techniques, depending on the specific material chosen. Thermal curing, curing by exposure to ultraviolet light, and air curing can all be suitable with some materials. The material itself can be any material with appropriate adherence properties, cured strength and stiffness, and handling characteristics. Examples of suitable materials include various foams, curable resins, starch compositions, and paste compositions.

### Example Application

FIG. 5(a,b) is a schematic representation of the preparation of an item for printing according to the present invention. An item 51 to be printed is substantially planar, but has thickness variations such as hemmed edges 53. In FIG. 5a, the item 51 is placed in contact with a coated substrate 52, forming a composite item 50. The thickness variations of the item 51 can produce gaps 54 between the item 51 and the coated substrate 52. The coated substrate 52 can have a conformable coating on the surface contacted by the printable item 51. Examples of suitable coatings include wax, settable resins, starch or paste compositions, and foams. The printable item 51 can be urged toward the coated substrate 52, for example by gravity or by applied pressure or vacuum. The conformable coating can be displaced by the pressure, remaining in the space 57 between the printable item 51 and the substrate 52, yielding a uniform thickness composite item as shown in FIG. 5b.

The characteristics of the conformable coating can be selected for the specific application, cost, and performance desired. As an example, the coated substrate can comprise waxed paper. The printable item can be pressed into the wax. The resistance to deformation of the wax can be altered by heating the wax before or while pressing. Removing the heat can then allow the wax to harden, filling in the gaps and adhering the printable item to the wax paper, yielding a uniform thickness composite item ready for printing. As another example, the coated substrate can comprise a thin plastic sheet coated with a UV-curable resin. The printable item can be urged toward the plastic sheet, displacing the resin and filling any gaps. The resin can then be cured by exposure to UV energy, yielding a uniform thickness composite item ready for printing.

### Example Apparatus

As an example, the present invention can be practiced with a pre-serged silk scarf blank. A polyurethane wax can be used as an adherent between the silk scarf blank and a substrate such as foam core or rice paper. The composite item (silk scarf blank, polyurethane wax, and substrate) can be subjected to heat and pressure such as that provided by a TEANECK heated graphic arts vacuum system. The heat can help activate the adherent, while the pressure can help in conforming the substrate to the scarf so that the final thickness and uniformity is attained. A graphic image, such as an image of a work of art or a person, can be printed on the resulting composite item using a printer such as an Epson 9800 Pro printer, with Epsom ultrachrome K3 inks. The printed item can be rinsed in cold water to help set the inks (depending on the specific inks chosen), and the substrate separated from the scarf; for example, if a water soluble substrate is used, then the cold water rinse can also remove the substrate.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1. A method of configuring a printable item for use with a printer, where the printer has a maximum allowable item thickness and a maximum allowable item thickness variation, and where the thickness of the printable item varies by more than the maximum allowable item thickness variation, comprising:
a) Providing a conformable substrate material;
b) Placing the printable item in contact with the substrate material, forming a composite item;
c) Treating the composite item such that the final thickness of the composite item is not more than the maximum allowable item thickness and such that the variation in thickness of the composite item is not more than the maximum allowable item thickness variation.

2. A method as in claim 1, wherein the printable item is a textile item.

3. A method as in claim 2, wherein the fabric item has at least a portion of its outer perimeter serged.

4. A method as in claim 2, wherein the fabric item comprises silk, cotton, poplin, wool, rayon, or twill.

5. A method as in claim 1, wherein the conformable substrate material comprises a compressible substrate material.

6. A method as in claim 5, wherein the compressible substrate material comprises at least one of cardboard, paper, and plastic.

7. A method as in claim 5, wherein treating the composite item comprises applying pressure to the composite item.

8. A method as in claim 7, wherein applying pressure to the composite item comprises passing the composite item through a roller press, wherein the space between the surfaces of the roller press is less than the maximum allowable item thickness.

9. A method as in claim 7, wherein applying pressure to the composite item comprises placing the composite item between parallel plates, and urging the parallel plates toward each other until their separation is not more than the maximum allowable item thickness.

10. A method as in claim 1, wherein the conformable substrate material comprises a thin sheet coated with a conformable material.

11. A method as in claim 10, wherein the conformable substrate material comprises paper with a wax coating thereon.

12. A method as in claim 11, wherein treating the composite item comprises heating the wax sufficient to soften the wax, then applying pressure substantially normal to the surfaces of the composite item, and then stopping heating the composite item.

13. A method of depositing an image on a printable item, comprising:
a) Providing a conformable substrate material;
b) Placing the printable item in contact with the substrate material, forming a composite item;
c) Treating the composite item such that the final thickness of the composite item is not more than the maximum allowable item thickness and such that the variation in thickness of the composite item is not more than the maximum allowable item thickness variation;
d) Presenting the composite item to a digital printer;
e) Providing a digital representation of the image to the digital printer
f) Using the printer to apply colors corresponding to the image to the printable item.

14. A method as in claim 13, wherein the printable item is a textile item.

15. A method as in claim 14, wherein the fabric item has at least a portion of its outer perimeter serged.

16. A method as in claim 14, wherein the fabric item comprises silk, cotton, poplin, wool, rayon, or twill.

17. A method as in claim 13, wherein the conformable substrate material comprises a compressible substrate material.

18. A method as in claim 17, wherein the compressible substrate material comprises at least one of cardboard, paper, and plastic.

19. A method as in claim 17, wherein treating the composite item comprises applying pressure to the composite item.

20. A method as in claim 19, wherein applying pressure to the composite item comprises passing the composite item through a roller press, wherein the space between the surfaces of the roller press is less than the maximum allowable item thickness.

21. A method as in claim 19, wherein applying pressure to the composite item comprises placing the composite item between parallel plates, and urging the parallel plates toward each other until their separation is not more than the maximum allowable item thickness.

22. A method as in claim 13, wherein the conformable substrate material comprises a thin sheet coated with a conformable material.

23. A method as in claim 22, wherein the conformable substrate material comprises paper with a wax coating thereon.

24. A method as in claim 23, wherein treating the composite item comprises heating the wax sufficient to soften the wax, then applying pressure normal to the surfaces of the composite item, and then stopping heating the composite item.

25. A method as in claim 13, wherein treating the composite item comprises applying an ink-retentive coating to a surface of the printable item.

26. An apparatus for configuring a printable item for use with a printer, where the printer has a maximum allowable item thickness and a maximum allowable item thickness variation, and where the thickness of the printable item varies by more than the maximum allowable item thickness variation, comprising:
a) Means for providing a conformable substrate material;
b) Means for placing the printable item in contact with the substrate material, forming a composite item;
c) Means for treating the composite item such that the final thickness of the composite item is not more than the maximum allowable item thickness and such that the variation in thickness of the composite item is not more than the maximum allowable item thickness variation.

27. An apparatus as in claim 26, wherein the conformable substrate material comprises a compressible substrate material.

28. An apparatus as in claim 27, wherein means for treating the composite item comprises means for applying pressure to the composite item.

29. An apparatus as in claim 28, wherein means for applying pressure to the composite item comprises a roller press, wherein the space between the surfaces of the roller press is less than the maximum allowable item thickness.

30. An apparatus as in claim 28, wherein means for applying pressure to the composite item comprises parallel plates, and means for urging the parallel plates toward each other until their separation is not more than the maximum allowable item thickness.
